(19) United States
(12) Patent Application Publication
(10) Pub. No.: US 2016/0128274 A1
(43) Pub. Date: May 12, 2016

(54) WAY OF MECHANIZED SEEDING (VERSIONS)

(71) Applicant: Sergei Vladimirovich Brindyuk, Alekseevka (RU)

(72) Inventor: Sergei Vladimirovich Brindyuk, Alekseevka (RU)

(21) Appl. No.: 14/920,540

(22) Filed: Oct. 22, 2015

Related U.S. Application Data
(63) Continuation of application No. PCT/RU2014/000286, filed on Apr. 21, 2014.

(30) Foreign Application Priority Data
Apr. 23, 2013 (RU) 2013118876

(51) Int. Cl. A01C 14/00; A01C 7/00; A01C 5/06

(52) U.S. Cl. CPC A01C 14/00; A01C 5/062; A01C 7/00

(57) ABSTRACT

There are suggested versions of seeding, including risk farming areas on black earth, gray, brown forest and chestnut soils, in which mechanized direct sowing of agricultural crops to the soil is carried out in the period, when absolute humidity of soil is more than 2% higher than the upper limit of humidity of physical maturity of soil, by its temperatures above zero, moreover, at sowing the furrows for seeds laying are forming with the width no more than 12 cm from 0.5 to 15 cm. Besides that, at sowing the energetic device, which has the opportunity to move along the ground with absolute humidity of more than 2 percent and up to 100 percent higher than the upper limit of humidity of soil physical maturity with the velocity from 6 to 80 km/h.

### CROSS REFERENCE TO RELATED APPLICATIONS

This is a Continuation of International Application PCT/RU201/000286, which has an international filing date of Apr. 21, 2014, and the disclosure of which is incorporated in its entirety into the present Continuation by reference. The following disclosure is also based on and claims the benefit of and priority under 35 U.S.C. §119(a) to Russian Patent Application No. RU 2013118876, filed April 23, 2013, which is also incorporated in its entirety into the present Continuation by reference.

### FIELD OF THE INVENTION

The patent belongs to agricultural production, namely to production of agricultural (a\c) sown crops.

### BACKGROUND

One of the problems of agricultural crops high yield receiving is the problem of their timely seeding, preservation of moisture in the soil and weed control.

High yield receiving depends on the level of moisture in the soil. For example, the summer wheat yield probable level, depending on the spring soil soaking depth (the data of experimental Swift Current (Canada) Station, table 1:

TABLE 1
Yield probable level,

| | Probability of crop yield, in c/ha | |
|---|---|---|
| Spring soil soaking depth, in cm | More than 10 | More than 17 |
| 0-50 | 2:10 | 0 |
| 50-68 | 3:10 | 1:10 |
| 68-82 | 6:10 | 2:10 |
| 82-112 | 7:10 | 3:10 |
| More than 112 | 9:10 | 6:10 |

As it seen, lack of moisture in the period of plant vegetation essentially lowers the yields. For moisture preservation and using it's important to optimize work, which is impossible by the traditional technologies, because they provide the achievement of physical maturity of soil, and after this the execution of works. (Soil condition, which displays its readiness to treatment (physical maturity) or to seeding and plants crop landing (biological maturity).

Physical maturity of soil is created by its some optimum moistening (humidity of mellow condition), when during mechanical restoration soil disintegrates to units (nubs) with sizes from 1 to 10 mm.

At a higher moisture soil adheres to tillage equipment and at a lower one it dilapidates to large lumps, clods.

Being under mature state soil crumbles better, offers the least resistance during the treatment, and in plowed soil optimum correlation between the hard part, water and air is achieved. Maturity of soil is determined visually, by nature of crumbling, throwing the soil off the shovel (or hurling a lump of soil, which is taken in a handful). Biological maturity is achieved in a well-crafted, optimally moistened and warmed soil. Great Soviet Encyclopedia.—M.: Soviet Encyclopedia. 1969-1978)

Nowadays existing technologies provide the expectation of period when soil gets physical maturity and will offer the least resistance to mechanical treatment. Dependence of the resistance to soil treatment and moisture can be tracked on the graph (look at FIG. 8), where “K” is the resistance of soil to treatment,” Wa” is absolute soil moisture.

During the plowing of parched soil (segment A [symbol] ) lumps with a diameter prior to 0.5 m and more are formed. While plowing the waterlogging soils (segment BΓ) forceful stuck and forming of clots and outgrowths of soil in front of tillage machine takes place. It comes to the growth of soil resistivity and bad plant residue sealing. With a further increase of moisture (segment Γ [symbol] ) water acts as a lubricant and “K∘” diminishes. But existing types of tillage and sowing machines are not capable to execute their functions by the higher moisture. For conventional types of equipment point B is considered to be the upper limit of physical maturity of soil. Among the different types of soils it differs and hesitates in the range of 15 to 35% of absolute humidity.

TABLE 2
Example. Typical loamy black soil.

| | Supreme field | Humidity of | Humidity of | |
|---|---|---|---|---|
| Type of soil, | water | rupture of | sustainable | Physical |
| mechanical | capacity (SFC, | capillaries | wilt | maturity, |
| structure | LC), % | (HRC), % | (HW), % | % |
| Typical loamy | 30-34 | 17-20 | 12-15 | 15-20 |
| black soil | | | | |

(look at “Characteristics of soil water properties”, written by Cauritchev I. S., 1989; Covrigo V. P., 2000)

It's well seen that becoming of physical maturity of soil coincides with the beginning of capillaries disruption (17-20%), which comes to the beginning of lack of moisture to the plant.

The lack of existing technologies manifests itself in the ineffective time loss while physical soil maturation is expected, during which big loss of moisture takes place in the result of evaporation.

At the limits of high humidity broadcast of seeding can be used, but it has one serious shortcoming for the most of a\c crops. In the case of lack of rains or watering the using of broadcast seeding can lead to crops damage, because the tillering node in example of springs is on the surface of the area of lack of moisture. It's necessary to immerse the seeds to the soil on the depth no less than 0.5 cm.

The method of crops production is known , it includes spudding, forming of estuarine soil profile, seeding by the way of stacking and indentation with the further mulching (look at the patent of RF No2378815 Kn. MIIK A01C7/00 of 17.04.2008).

The method of crops production is known, it includes operation of autumn and spring soil loosening, seed sowing to the treated soil and seed furrow sealing (look at “Technology and technical means for the lane sowing of grass seeds to the sod”). Recommendations of the Agriculture Research Institute of north-east, named after N. V. Rudnitsky—Kirov, 2000—58 pages, prototype).

The general shortcomings of the known methods are low efficiency of crop farming works, essential moisture losses during spring loosening, complexity of compliance of optimum seeds sowing agricultural terms because of need to carry out the seedbed spring plowing operation, which is almost impossible in the case of physically immature soils.

### SUMMARY

The task of submitted invention is increasing in efficiency of crop farm works, namely:

reduction of losses of spring moisture reserves in soil,

optimization of sowing dates,

obtaining of energetically powerful shoots,

offset of seeding terms range to the earlier period,

reduction of dependence of sowing works on soil condition,

improvement of environmental performance of agricultural production, and consequently of produced crops,

reduction of negative impact of seeding system to the soil, and influence of the last one to the seeding system elements,

rising of sowing rate,

increase of period of crops vegetative growth,

reduction of specific fuel expense,

reduction of mass and overall characteristics of seeding system.

Delivered task is determined by the way that in known case of mechanized seeds sowing including risk farming areas on black earth, gray, brown forest and chestnut soils, stipulated on the entering of seeds into the soil according to invention of mechanized direct seeds sowing of agriculture crops to the soil is realized in the period, when absolute humidity of soil is more than 2% higher than the upper limit of humidity of physical maturity of soil, by its temperatures above zero, by the way in the process of sowing furrows for seeds laying are formed with the width no more than 12 cm, the depth of seeds sowing is choosing between the limits from 0.5 to 15 cm.

Besides that, at sowing the energetic device, which have the opportunity to move along the ground with absolute humidity more than 2 percents and up to 100 percents higher than the upper limit of humidity physical maturity of soil is used, the device velocity is from 6 to 80 km/h, for example “BARS UTEV 271” or hovercraft device, but the direct sowing is carrying out immediately by sprouted weeds without preliminary operation of soil cultivation by their liquidation, 1-5 days before the seedling of crops soil mulching by the way of chemical treatment of weeds with herbicides of continuous action is conducted with the help of sprayer installed on the energetic device, which have the opportunity to move along the ground with absolute humidity of more than 2 percents and up to 100 percents higher than the upper limit of humidity of physical maturity of soil with the velocity from 6 to 80 km/h, for example “BARS YT [symbol] C 271” or hovercraft device.

The second version of the way of mechanized seeds sowing including risk farming areas on black earth, gray, brown forest and chestnut soils, stipulated on the entering of seeds into the soil is the way, in which according to invention of mechanized direct seeds sowing of agriculture crops to the soil is realized in the period, when absolute humidity of soil is more than 2% higher than the upper limit of humidity of physical maturity of soil by its temperatures above zero, and the seeds on the exit of seed dispensing device are given the speed more than one of the air flow from it.

The third version of the way of mechanized seeds sowing including risk farming areas on black earth, gray, brown forest and chestnut soils, stipulated on the entering of seeds into the soil is the way, in which according to invention of mechanized direct seeds sowing of agriculture crops to the soil is realized in the period, when absolute humidity of soil is more than 2% higher than the upper limit of humidity of physical maturity of soil, by its temperatures above zero, but at sowing seeds velocity on the exit of seed dispensing devices give no less than 35 m/c and up to supersonic velocities, by the way at sowing the energetic device, which has the opportunity to move along the ground with humidity of more than 2 percents and up to 100 percents higher than the upper limit of humidity of physical maturity of soil with the velocity from 6 to 80 km/h, for example “BARS UTEV 271” or hovercraft device.

The fourth version of the way of mechanized seeds sowing including risk farming areas on black earth, gray, brown forest and chestnut soils, stipulated on the entering of seeds into the soil is the way, in which according to invention of mechanized direct seeds sowing of agriculture crops to the soil is realized in the period, when absolute humidity of soil is more than 2% higher than the upper limit of humidity of physical maturity of soil, by its temperatures above zero, and at seeding the seeds on exit of seed dispensing device are given the speed no less than 35 m/c and up to supers.velocities, the seeds velocities are regulated in auto mode, depending on the hardness of the soil and\or on conditions of sowing, by the way at sowing the energetic device, which has the opportunity to move along the ground with absolute humidity of more than 2 percents and up to 100 percents higher than the upper limit of hum. of physical maturity of soil with the velocity from 6 to 80 km/h, for example “BARS UTEV 271” or hovercraft device.

The fifth version of the way of mechanized seeds sowing including risk farming areas on black earth, gray, brown forest and chestnut soils, stipulated on the entering of seeds into the soil is the way, in which according to invention of mechanized direct seeds sowing of agriculture crops to the soil is realized in the period, when absolute humidity of soil is more than 2% higher than the upper limit of hum. of physical soil maturity by its temperatures above zero, moreover at seeding the cold-resistant plants seeds, which are tolerable to cold are used.

The sixth version of the way of mechanized seeds sowing including risk farming areas on black earth, gray, brown forest and chestnut soils, stipulated on the entering of seeds into the soil is the way, in which according to invention of mechanized direct seeds sowing of agriculture crops to the soil is realized in the period, when absolute humidity of soil is more than 2% higher than the upper limit of hum. of physical maturity of soil, by its temperatures above zero, but seeds sowing is realized by zigzag and wave trajectories, by the way when the last ones are formed on account of creation of free oscillations possibility under the action of heterogeneities of soils of free fixed or spring-loaded vomers with amplitude no less than 5% of the aisles width.

Indicated summation of attributes shows new properties, which lie in the fact that owing to their using occurs:

reduction of spring moisture reserve losses in the soil (because the works are realized in the period, when absolute soil humidity is more than 2% higher than the upper limit of humidity of physical maturity of soil and most part of it stays in the soil).

optimization of sowing works terms (because the last ones are realized in the period, when absolute humidity of soil is more than 2% higher than the upper limit of humidity of physical maturity of soil, namely in the period, when for some cultures, for example for barley it's optimal by technical indicators).

receiving of energetically powerful shoots (in consequence of optimal terms of sowing and crops shoots by the increased soil humidity).

transfer of sowing terms range to the earlier period (because works are realized in the period, when absolute soil humidity is more than 2% higher than the upper limit of humidity of physical maturity of soil),

reduction of dependence of sowing works on the soil condition (because suggested seeding and tillage systems give the opportunity to realize the sowing works, including the last ones in the period, when absolute soil humidity is more than 2% higher than the upper limit of humidity of physical maturity of soil),

making more eco-friendly the agriculture production, and consequently of sowing agriculture crops (which is the result of total reduction of herbicides and chemical fertilizers using in the condition of increased fruitfulness of sowing agriculture crops.

reduction of negative influence of a\c complex to the soil and of the last one to complex elements (in consequence of reduction of sowing complex total weight the soil is less rammed and in consequence of more watery ground the last one renders more ineffectual influence to complex elements),

rising of sowing works terms (to which more ineffectual resistance of soil to work complex elements promotes),

increasing of vegetative sowing development terms (to which earlier a\c terms conducting promotes),

reduction of specific fuel expense (in consequence of increased velocities of a\c terms conducting and more ineffective resistance of soil to working elements of working complex),

reduction of mass and overall characteristics of sowing system (the opportunity appears in consequence of reduced ladings to elements of the system).

Besides that, to moisture preservation in the soil withered after chemical treatment weeds, which shut the soil surface promote.

At increasing of humidity of soil reference and coupling rates of propeller diminish, therefore immersion to the depth of more than 15 cm or forming of furrow for seeds packing with the depth of more than 12 cm (look at FIG. 1, where “e” is the furrow width for seeds packing, “h” is the depth of seeds immersion) requires much energy expenses and it's economically unfeasible.

Nowadays in the capacity of energetic means for seeding machines functioning tractor-ploughs are used for the most part.

On the ground of norm of propeller influence upon the soil (State All-Union Standard 26955-86) norms of maximum pressure of propellers to loamy and clayey soil and ones of normal mechanical strain in the soil must correspond to the requirements indicated in table 3. Norm data legibly indicate that under the condition of physical maturity of soil in the upper limit in spring season pressure mustn't exceed 80 kPa, where the least (field) water capacity (LC) corresponds to the capillary-suspended saturation of soil with water, when the last is maximum available for plants.

TABLE 3
Norms of maximum pressure of propellers

| | Maximum pressure exerted on the soil | |
|---|---|---|
| | by wheeled and crawler propellers, | |
| Soil moisture | in kPa, no more than | |
| in the layer of 0-30 cm | Spring season | Summer-autumn season |
| More than 0.9 LC | 80 | 100 |
| 0.7 LC to 0.9 LC inclusively | 100 | 120 |
| 0.6 LC 0.7 LC | 120 | 140 |
| 0.5 LC 0.6 LC | 150 | 180 |
| 0.5 LC and less | 180 | 210 |

In the case of excess of these limits formation of ruts and soil puddling take place, which substantially affects on fruitfulness.

For movement on the soil ground with absolute humidity of more than 2 percents and up to 100 percents higher than the upper limit of humidity of physical maturity of soil utilization of ground vehicles with pressure less than 60 kPa, namely “BARS UTEV 271” on elastic tires on envelopes of ultra-low pressure (5-60 kPa) tires (look at FIG. 2) or hovercraft device. The sequence of sowing by point 3 is indicated in FIG. 3, where “a” is untreated field, “b” is sitting on weeds, “c” is chemical treatment with herbicides, “d” indicates seedlings for withered weeds.

Nowadays sowing complexes with pneumatic seeding, that is to say with pneumatic transportation of seeds from hopper to vomer are widely used. The given way of transportation of seeds allowed to make more fine-draw weight distribution in system by the way of displacement of hopper remotely from vomers, and also allowed to displace additional equipment in the form of cultivator paws and disks, which perform auxiliary operations by soil tillage in frames of complex. At pneumatic seeder the delivery of seeds to vomer is performed by air and at the exit from seeds passage seeds velocities are lower or equal to air velocity, which comes to further movement of seeds in the direction of air flow. At the exit of air from seeds passage the air changes the motion vector backwards to soil, as a result of which a part of seeds is inflated from seed furrow, which comes to bad-quality seeding. In suggested way (version 2), in which seeds velocities at the exit are formed higher than air velocity V₁>V₂ (which is realized with the help of construction of seeds passage, which have different profiles in its cross-section) the influence of air flow to the vector of seeds motion decreases. The seeds, which have the vector directed to the soil achieve her and are not inflated, which is necessary for effectual seeding. (look at FIG. 4, where: 1—vomer, 2—seeds passage, 3—soil, 5—seeds, 10—seedbed, V₁—velocity of seeds, V₂—velocity of air flow)

Increment of seeds velocity of more than 35 m/sec is inappropriate by traditional sowing, because at absolute humidity of less than 2% higher than the upper limit of humidity of soil physical maturity by its temperatures above zero the soil has higher hardness than by the absolute humidity of soil of more than 2% higher than the upper limit of humidity of physical maturity of soil, by its temperatures above zero, which comes to damage of seeds stricken by the ground and reduction of germination. At sowing into the soil, which has absolute soil humidity of more than 2% higher than the upper limit of humidity of physical soil maturity, by its temperatures above zero the increment of seeds velocities (version 3) will allow the seeds to make more close contacts with soil. Accelerated seeds get caught in it, which promotes to better germination, and in the case of seeds velocities are regulated automatically depending on the soil hardness and\or sowing conditions (version 4) the sowing velocity increases and together with it the effectiveness of sowing works increases.

Utilization of seeds of cold-resistant plants , steady to cold a/c crops in the spring season during very early sowing to the soil with high humidity (version 5) in the case of change of weather in the direction of cooling and temperature lowering below zero will allow the plants not to fall in this period, to create uniform seedlings, which also raises the sowing works effectiveness.

The seeding is divided into drill, solid drill, closed drill, widely drill and belt; square-cluster. The main task of seeding is the uniform distribution on the field by area and depth, which comes to more uniform distribution of nutrients between plants. Generally, the above said types of seeding it's reached on the account of increment of depth of furrow for seeds laying or by repeated sowing. Increment of depth of furrow for seeds laying or repeated sowing comes to essential growth of energy costs. Suggested solution (version 6) allows to dispense seeds on the field more evenly and optimally by the way of seeding by zigzag and wave trajectories, because the total length of furrow on the field rises to 50%, without additional operations and energy costs, which raises the seeding works efficiency.

This way, suggested set of attributes shows new properties consisting in the fact that due to their applying spring moisture losses reduce, and it becomes possible to optimize sowing terms that in the whole comes to rising of seeding works efficiency.

Besides that, also weeds, which withered after chemical treatment shut themselves the soil surface and are instrumental in preservation of soil moisture. Consequently, submitted invention corresponds to criteria “Newness” and “Inventive step”.

Correspondence to criterion “Industrial applicability” is proved by the example of particular application of offered invention, which is shown below.

### DESCRIPTION OF THE DRAWINGS

On the FIGS. 1-5 suggested technical solutions are shown schematically.

FIG. 1 Planting scheme (where “e” is furrow width, “h”—its depth)

FIG. 2 Power tool “BARS UTEV 271” (where “P” is tire pressure),

FIG. 3 The sequence of works by the way of p. 3, (where “a” is untreated field, “b” is sitting on weeds, “c” is chemical treatment by herbicides, “d” indicates seeding for withered weeds.

FIG. 4 The way of seeding by point 4 (where V₁>V₂, “V₁” is the seeds velocity, “V₂” is the air velocity).

FIG. 5 Seeding by zigzag and wave trajectories (where: “L” is amplitude of free oscillation of vomers, “k” is the aisles width).

FIG. 6 General form of condition of seeding, which is performed by suggested way.

FIG. 7 General form of condition of seeding, which is performed by traditional way.

FIG. 8 Graph of dependence of resistance of soil to its processing against humidity.

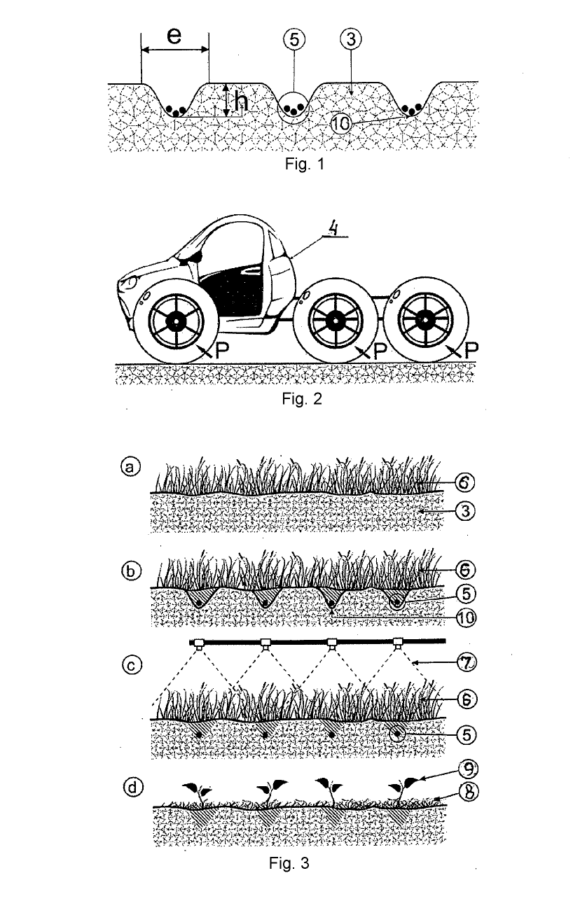

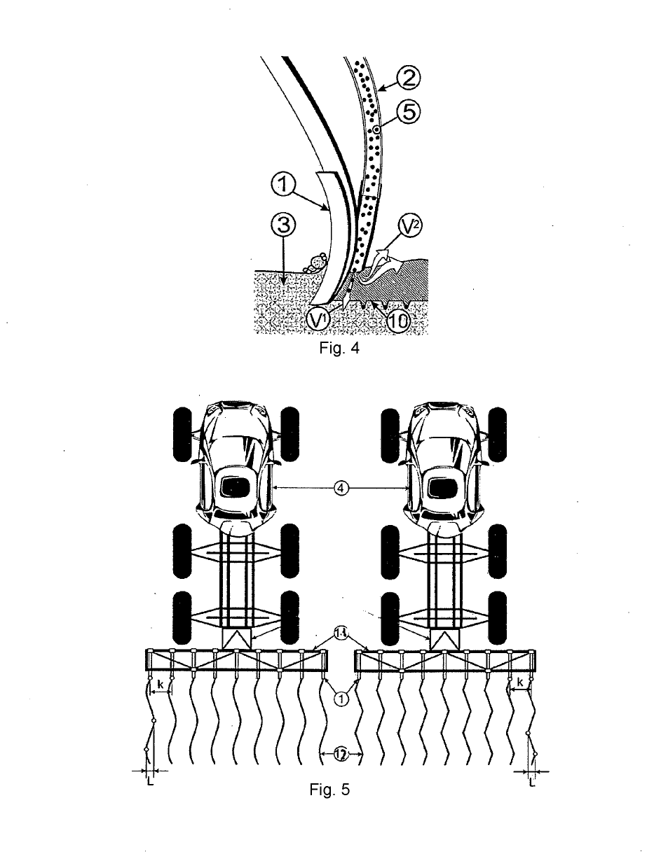

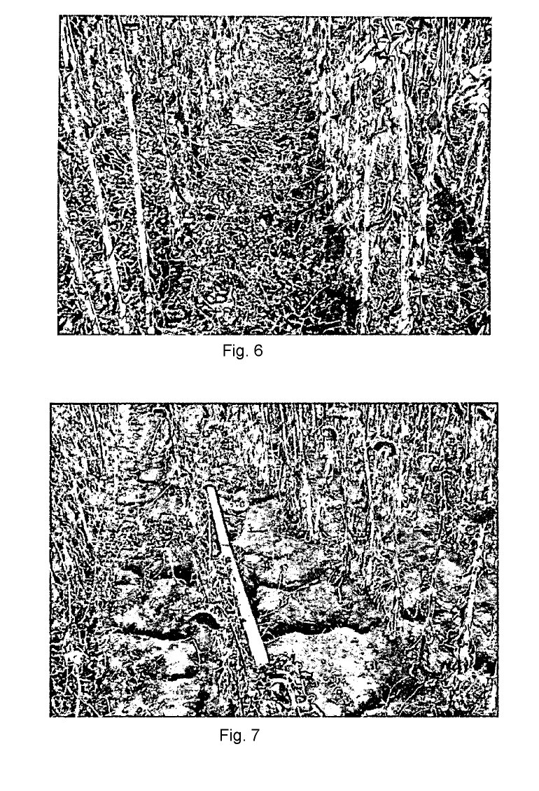

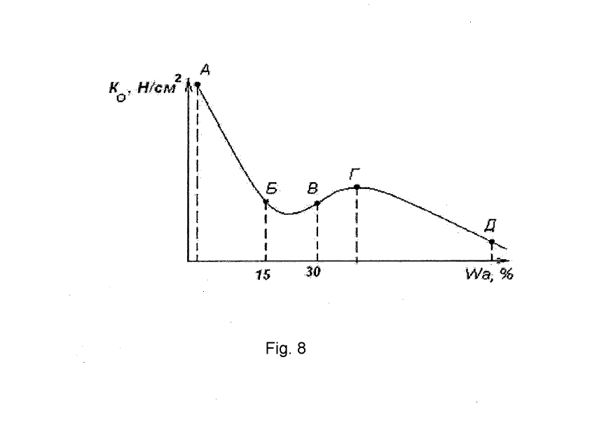

Approbation of suggested way of increase in efficiency of agricultures seeding has been conducting on the example of as such agriculture as a sunflower in the farm OOO “I-OH [symbol] ” Limited of Olkhovatsky district, Voronezh region. With the aim of increase of expertise reliability the field with total area equal to 123 hectares was shared on two parts. On the first part of the field cultivation of sunflower has been conducting by traditional way, and on the second by developed one.

Suggested way, as a traditional one has provided the autumn soil preparation, which includes loosening and ravage of weeds. Nevertheless, in spring time, before the seeding holding no operations with soil have been conducting. The seeding has been done to the soil, directly to the sprouted weeds, without preliminary cultivation, the soil was prepared in autumn. The seeding on the part of field, which was treated by suggested way were made 18 earlier than one, performed traditionally (because the soil temperature regime by that time has become optimal for the growth of cold-resistant seeds of sunflower), the seeding has been conducting immediately after rain, with soil humidity of 50%.

Five days after seeding, with the help of universal transport and technical means on ultra-low pressure tires “BARS-271” chemical treatment by herbicides of continuous action were performed. The wheeled propeller of present vehicle renders pressure to the soil of about 17 kPa, that is why formation of track hasn't taken place, and consequently by the depth of seeding of about 5 cm no sprouting seeds in the soil has been damaged.

Carrying out of the chemical weeding before arising of seeds shoots permitted to liquidate weeds and not to depress the growth of culture crops. High efficiency of chemical treatment has been achieving by low-volume sprayer with consumption of working liquid of 20-60 l/h using. The withered weeds have created the areal “umbrella” (pos. 8 on FIG. 3; FIG. 6), which allowed to protect the aisle from direct sunshine, and consequently to reduce evaporation of moisture and soil cracking, as well as to prevent the growth of weeds of the second wave.

The sunflowers planted on the second part of field have matured 10 days before than ones planted as usually. Maturation of sunflowers has happened earlier owing to the fact that seeds have been put to the soil with optimum temperature; there was no direct contact between cultivated plant and herbicide; withered weeds hasn't allowed the soil to heat up strongly and crack, that is why the moisture in soil has been saved.

Traditionally, the chemical treatment was held after the young growth of sunflowers appeared, with the help of self-propelled sprayer, and the soil wasn't protected from the light of a sun. The characteristic feature was the fact that for the whole summer time there was no rain on this field. On this part of field the soil was covered with deep fractures (FIG. 7).

The fruitfulness on that part of field, which was cultivated by the suggested way has come to 22.39 c/ha, and by traditional one-to 9.1 c/ha, the difference in fruitfulness was 13.29 c/ha (confirmed results).

Additional approbation of suggested way has been performed in OOO “Rusagro-Invest” Ltd on the field with the area of 108 h. The results of the harvest have showed that fruitfulness of the sunflowers, which were cultivated by suggested way has come to 24.1 c/ha, by the middle fruitfulness of sunflower in the farm of 16.2 c/ha. The difference in fruitfulness has been 7.9 c/ha (the results are confirmed with the act).

This way, the using of suggested way allows to get the next technical results, namely:

reduction of losses of spring soil moisture reserves,

optimization of seeding works terms,

receiving of energetically strong shoots,

displacement of the range of seeding works terms to the earlier period,

reduction of dependence of seeding works from soil condition,

making more eco-friendly the agricultural production, and consequently the produced crops,

reduction of negative influence of seeding complex to the soil, and of the last one to seeding system elements,

increase of speed of seeding works,

increase of terms of vegetative crops growth,

reduction of mass and overall characteristics of seeding system.

allows to raise the fruitfulness of agricultural crops;

decreases the influence of weather to fruitfulness;

reduction of specific fuel consumption, because:

a) fuel consumption in UTEV-271 “BARS” is 0.2 l/h, and the cost of consumed combustible for the shift is 1692 roubles; self-propelled sprayer JohnDeere 4930 with fuel consumption of 1,2 l/h, the cost of consumed combustible for the shift comes to 5200 roubles);

b) savings in transportation of water for preparation cooking: transportation costs for water delivery for the shift with UTEV-271 “BARS” using are 302 roubles, and for self-propelled sprayer “JohnDeere 4930 they come to 1646 roubles.

c) savings of herbicide during the using of UTEV-271 “BARS” come to 20-30%.

### LIST OF REFERENCE SIGNS

1 vomer
2 seeds passage
3 soil
4 power tool
5 seeds
6 weeds
7 sprayer
8 withered weeds
9 culture plantlets
10 seedbed
11 sowing machine
12 furrow for seeding

What is claimed is:

1. A mechanized seed sowing method including risk farming areas on black earth, gray, brown forest and chestnut soils, stipulated on optimization of terms of their holding, wherein the mechanized sowing of agricultural crops to the soil is carried out in the period, when absolute humidity of soil is more than 2% higher than the upper limit of humidity of physical soil maturity by its temperatures above zero, and at sowing the furrows for seeds laying are formed with the width of more than 12 cm, the depth of seeding is chosen from 0.5 to 15 cm.

2. The method according to claim 1, wherein at sowing the energetic device, which has the opportunity to move along the ground with absolute humidity of more than 2 percent and up to 100 percent higher than the upper limit of humidity of physical maturity of soil with the velocity from 6 to 80 km/h.

3. The method according to claim 1, wherein seeds sowing is carried out directly by sprouted weeds without preliminary cultivation of soil to destroy weeds, and 1-5 days before the emergence of seedlings the mulching of soil is conducted with the help of chemical treatment of weeds by herbicides of continuous action, with the help of sprayer mounted on the energetic device, which has the opportunity to move along the ground with absolute humidity of more than 2 percent and up to 100 percent higher than the upper limit of physical maturity of soil with the velocity from 6 to 80 km/h.

4. A mechanized seed sowing method including risk farming areas on black earth, gray, brown forest and chestnut soils, stipulated on optimization of terms of their holding, wherein the mechanized sowing of agricultural crops to the soil is carried out in the period, when absolute humidity of soil is more than 2% higher than the upper limit of humidity of soil physical maturity by its temperatures above zero, and at the outlet of seed dispensing device the seeds are given the velocities that are more than the last ones of the air flow from it.

5. A mechanized seed sowing method including risk farming areas on black earth, gray, brown forest and chestnut soils, stipulated on optimization of terms of their holding, wherein the mechanized sowing of agricultural crops to the soil is carried out in the period, when absolute humidity of soil is more than 2% higher than the upper limit of humidity of soil physical maturity by its temperatures above zero, and at the outlet of seed dispensing device the seeds velocities come to no less than 35 m/sec and up to supersonic velocity, by the way at sowing the energetic device, which has the opportunity to move along the ground with absolute humidity of more than 2 percent and up to 100 percent higher than the upper limit of physical maturity of soil with the velocity from 6 to 80 km/h.

6. A mechanized seed sowing method including risk farming areas on black earth, gray, brown forest and chestnut soils, stipulated on optimization of terms of their holding, wherein the mechanized sowing of agricultural crops to the soil is carried out in the period, when absolute humidity of soil is more than 2% higher than the upper limit of humidity of soil physical maturity by its temperatures above zero, moreover at sowing at the outlet of seed dispensing device the seeds are given the velocities, which come to no less than 35 m/sec and up to supersonic velocity, and seeds velocities are regulated in auto mode, depending on the soil hardness and\or the sowing conditions, by the way at sowing the energetic device, which has the opportunity to move along the ground with absolute humidity of more than 2 percent and up to 100 percent higher than the upper limit of humidity of physical maturity of soil with the velocity from 6 to 80 km/ha.

7. A mechanized seed sowing method including risk farming areas on black earth, gray, brown forest and chestnut soils, stipulated on optimization of terms of their holding, wherein the mechanized sowing of agricultural crops to the soil is carried out in the period, when absolute humidity of soil is more than 2% higher than the upper limit of humidity of soil physical maturity, by its temperatures above zero, moreover at sowing cold-resistant plant seeds.

8. A mechanized seed sowing method including risk farming areas on black earth, gray, brown forest and chestnut soils, stipulated on optimization of terms of their holding, wherein the mechanized seeds sowing of agricultural crops to the soil is carried out in the period, when absolute humidity of soil is more than 2% higher than the upper limit of humidity of soil physical maturity, by its temperatures above zero, seeds sowing is realized by zigzag and wave trajectories, and besides the last ones are forming on account of creation of free oscillations possibility under the influence of heterogeneities of the ground of free fixed or spring-loaded vomers with the amplitude of no less than 5% of the aisles width.

9. The method according to claim 2, wherein the sowing is performed with a “BARS UTEV 271” or a hovercraft device.

10. The method according to claim 3, wherein the sowing is performed with a “BARS UTEV 271” or a hovercraft device.

11. The method according to claim 5, wherein the sowing is performed with a “BARS UTEV 271” or a hovercraft device.

12. The method according to claim 6, wherein the sowing is performed with a “BARS UTEV 271” or a hovercraft device.
